(19) United States
(12) Patent Application Publication
(10) Pub. No.: US 2015/0357901 A1
(43) Pub. Date: Dec. 10, 2015

(54) VOLTAGE SOURCE CONVERTER

(71) Applicant: ALSTOM Technology Ltd., Baden (CH)

(72) Inventors: Colin Oates, Stafford (GB); Kevin J. Dyke, Stafford (GB); David Reginald Trainer, Derby (GB)

(73) Assignee: ALSTOM TECHNOLOGY LTD, Baden (CH)

(21) Appl. No.: 14/760,450

(22) PCT Filed: Dec. 6, 2013
(86) PCT No.: PCT/EP2013/075842

§ 371 Date: Jul. 10, 2015

(30) Foreign Application Priority Data
Jan. 11, 2013 (EP) 13275007.6

(51) Int. Cl. H02M 1/12; H02M 7/06

(52) U.S. Cl. CPC H02M 1/12; H02M 7/066

(57) ABSTRACT

A voltage source converter includes a converter limb extending between DC terminals and having limb portions separated by an AC terminal, the DC terminals being connectable to a DC electrical network and the AC terminal being connectable to an AC electrical network. Each limb portion includes at least one switching element and a chain-link converter including a series-connected modules, each module including at least one switching element and at least one energy storage device combining to selectively provide a voltage source. The chain-link converter is connected to the AC terminal, and the switching element(s) of each limb portion is switchable to switch the chain-link converter into and out of circuit with the corresponding DC terminal. The voltage source includes a control unit which coordinates the switching of the switching elements of the limb portions and the switching element(s) in each module of the chain-link converter.

This invention relates to a voltage source converter.

In power transmission networks alternating current (AC) power is typically converted to direct current (DC) power for transmission via overhead lines and/or under-sea cables. This conversion removes the need to compensate for the AC capacitive load effects imposed by the transmission line or cable, and thereby reduces the cost per kilometer of the lines and/or cables. Conversion from AC to DC thus becomes cost-effective when power needs to be transmitted over a long distance.

The conversion of AC power to DC power is also utilized in power transmission networks where it is necessary to interconnect the AC networks operating at different frequencies.

In any such power transmission network, converters are required at each interface between AC and DC power to effect the required conversion, and one such form of converter is a voltage source converter (VSC).

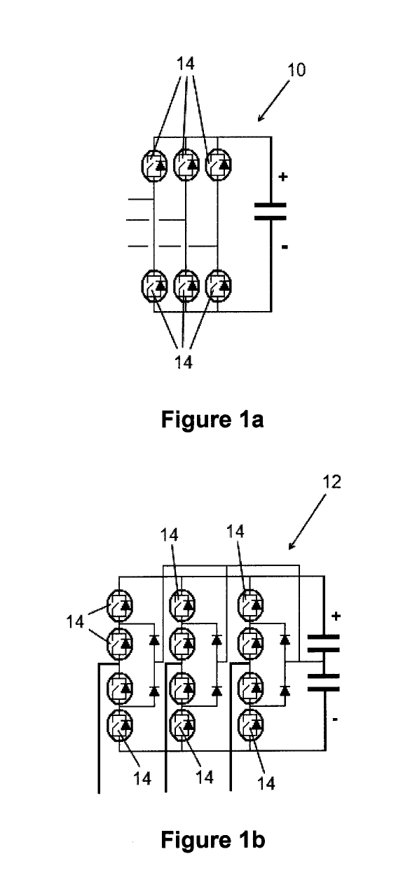

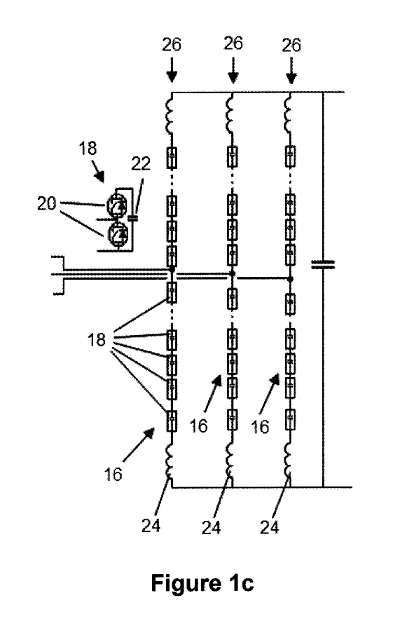

It is known in voltage source converters to use six-switch (two-level) and three-level converter topologies 10,12 with insulated gate bipolar transistors (IGBT) 14, as shown in FIGS. 1a and 1b. The IGBT devices 14 are connected and switched together in series to enable high power ratings of 10's to 100's of MW to be realized. In addition, the IGBT devices 14 switch on and off several times at high voltage over each cycle of the AC supply frequency to control the harmonic currents being fed to the AC network. This leads to high losses, high levels of electromagnetic interference and a complex design.

It is also known in voltage source converters to use a multi-level converter arrangement such as that shown in FIG. 1c. The multi-level converter arrangement includes respective converter bridges 16 of cells 18 connected in series. Each converter cell 18 includes a pair of series-connected insulated gate bipolar transistors (IGBTs) 20 connected in parallel with a capacitor 22. The individual converter cells 18 are not switched simultaneously and the converter voltage steps are comparatively small. The capacitor 22 of each converter cell 18 is configured to have a sufficiently high capacitive value in order to constrain the voltage variation at the capacitor terminals in such a multi-level converter arrangement, and a high number of converter cells 18 are required due to the limited voltage ratings of the IGBTs 20. A DC side reactor 24 is also required in each converter bridge 16 to limit transient current flow between converter limbs 26, and thereby enable the parallel connection and operation of the converter limbs 26. These factors lead to expensive, large and heavy equipment that has significant amounts of stored energy, which makes pre-assembly, testing and transportation of the equipment difficult.

According to an aspect of the invention, there is provided a voltage source converter comprising:
a converter limb extending between first and second DC terminals and having first and second limb portions separated by an AC terminal, the first and second DC terminals being connectable to a DC electrical network and the AC terminal being connectable to an AC electrical network, each limb portion including at least one switching element;
a chain-link converter including a plurality of series-connected modules, each module including at least one switching element and at least one energy storage device, the or each switching element and the or each energy storage device of each module combining to selectively provide a voltage source, the chain-link converter being connected to the AC terminal, the or each switching element of each limb portion being switchable to switch the chain-link converter into and out of circuit with that limb portion and thereby switch the chain-link converter into and out of circuit with the corresponding DC terminal; and
a control unit which coordinates the switching of the switching elements of the limb portions and the or each switching element in each module of the chain-link converter to transfer power between the AC and DC electrical networks,
wherein the control unit controls the switching of the or each switching element in each module of the chain-link converter to generate an AC voltage waveform at the AC terminal, the AC voltage waveform including an AC voltage waveform portion between positive and negative peak values of the AC voltage waveform, the AC voltage waveform portion including at least two different voltage profiles to filter one or more harmonic components from the AC voltage waveform, at least one of the different voltage profiles being defined by a non-zero voltage slope.

For the purposes of this specification, a voltage slope is defined as a constant rate of change of voltage (which can be negative, zero or positive) over a defined period. It follows that a non-zero voltage slope is defined as a negative or positive constant rate of change of voltage over a defined period, and a zero voltage slope is defined as a zero rate of change of voltage over a defined period.

The AC voltage waveform portion including at least two different voltage profiles has at least one common point of intersection between different voltage profiles over the period of the AC voltage waveform portion.

At least two of the different voltage profiles may be defined by different voltage slopes. Hence, an AC voltage waveform portion including at least two different voltage slopes has at least two different constant rates of change of voltage and at least one common point of intersection between different voltage slopes over the period of the AC voltage waveform portion. For example, when the AC voltage waveform portion has first and second different voltage slopes (i.e. first and second constant rates of change of voltage which are different to each other), at least one section of the AC voltage waveform portion has the first voltage slope (i.e. the first constant rate of change of voltage), at least one other section of the AC voltage waveform portion has the second voltage slope (i.e. the second constant rate of change of voltage) and the AC voltage waveform portion includes at least one common point of intersection between sections with different voltage slopes.

At least one of the different voltage profiles may be defined by an instantaneous change in voltage.

It will be appreciated that, since at least one of the different voltage profiles of the AC voltage waveform portion is defined by a non-zero voltage slope, the AC voltage waveform portion is distinguished from a stepped voltage waveform (e.g. a square or rectangular voltage waveform) that consists of vertical and horizontal sections. This is because the vertical section of the stepped voltage waveform is defined by an instantaneous change in voltage and thereby does not have a defined voltage slope, while the horizontal section is defined by a zero voltage slope.

Firstly the configuration of the voltage source converter according to the invention permits the chain-link converter to provide a variable voltage to generate and control the configuration of the AC voltage waveform at the AC terminal and thereby control the voltage experienced by the switching elements in the limb portions. This is because the chain-link converter is capable of providing a stepped variable voltage source, which permits the generation of a voltage waveform across the chain-link converter using a step-wise approximation.

Such generation and control of the configuration of the AC voltage waveform at the AC terminal not only permits soft-switching of the limb portions, but also reduces the risk of damage caused by voltage levels exceeding the voltage ratings of the switching elements of the limb portions. In turn, the voltage source converter becomes easier to design and manufacture because the switching elements of the limb portions can be chosen without having to consider the possibility of voltage levels exceeding the voltage ratings of the switching elements. Moreover the chain-link converter can be switched to control the configuration of the AC voltage waveform at the AC terminal to prevent the voltage at the AC terminal from ramping too quickly, thus causing fast fronted and high voltage spikes that may damage or degrade components or their insulation.

The modular arrangement of the chain-link converter means that it is straightforward to increase or decrease the number of modules in the chain-link converter to achieve a desired voltage rating of the voltage source converter.

Secondly the inclusion of at least two different voltage profiles in the AC voltage waveform portion, with at least one of the different voltage profiles being defined by a non-zero voltage slope, as described above increases the number of degrees of freedom of the AC voltage waveform, the degrees of freedom being given by the values of the voltage profiles of the AC voltage waveform portion which correspond to each point at which the respective voltage profile in the AC voltage waveform portion intersects with another voltage profile. It will be appreciated that the number of voltage profiles in the AC voltage waveform portion may be varied to adjust the number of degrees of freedom of the AC voltage waveform.

The control unit may be configured to control the switching of the or each switching element in each module of the chain-link converter to control the configuration of the AC voltage waveform portion at the AC terminal when the chain-link converter is switched out of circuit with both limb portions.

The increased number of degrees of freedom of the AC voltage waveform enables the control unit to control the switching of the or each switching element in each module of the chain-link converter to generate an AC voltage waveform in a manner that permits filtering of one or more harmonic components from the AC voltage waveform, examples of which are as follows.

Optionally, the control unit may control the switching of the or each switching element in each module of the chain-link converter to modify the value of each intercept angle of the AC voltage waveform and thereby filter out one or more harmonic components from the AC voltage waveform. For the purposes of the specification, an intercept angle is defined as a phase angle corresponding to a common point of intersection between two different voltage profiles of the AC voltage waveform.

Further optionally, the control unit may control the switching of the or each switching element in each module of the chain-link converter to modify the magnitude of the AC voltage waveform corresponding to each intercept angle of the AC voltage waveform and thereby filter out one or more harmonic components from the AC voltage waveform.

The capability of the voltage source converter according to the invention to generate, at the AC terminal, an AC voltage waveform including an AC voltage waveform portion with at least two different voltage profiles, with at least one of the different voltage profiles being defined by a non-zero voltage slope, therefore enables the voltage source converter to transfer high quality power between the AC and DC electrical networks.

Such operation of the voltage source converter to enable transfer of high quality power between the AC and DC electrical networks permits simplification of the design and construction of the limb portions without adversely affecting the performance of the voltage source converter according to the invention. For example, each limb portion may include a single switching element or a plurality of switching elements connected in series between the AC terminal and a respective one of the DC terminals. Switching elements with high voltage ratings can be selected for use in the limb portions to further reduce the footprint of the voltage source converter and thereby minimise the real estate costs of the associated power station.

In addition the connection of the chain-link converter to the AC terminal as set out above permits reduction in the required number of modules per converter limb and per AC phase in comparison to a conventional voltage source converter having the same number of converter limbs, each converter limb including a plurality of modules, an example of which is shown in FIG. 1c. As such the reduction in the overall number of modules provides further savings in terms of the cost, size and footprint of the voltage source converter.

The configuration of the voltage source converter according to the invention therefore results in an efficient, cost- and space-saving voltage source converter with high voltage capabilities.

In embodiments of the invention, the or each switching element and the or each energy storage device of each module may combine to selectively provide a bidirectional voltage source. In such embodiments, each module may include two pairs of switching elements connected in parallel with an energy storage device in a full-bridge arrangement to define a 4-quadrant bipolar module that can provide negative, zero or positive voltage and can conduct current in two directions.

In the voltage source converter according to the invention, each limb portion may include a single switching element or a plurality of switching elements connected in series between the AC terminal and a respective one of the DC terminals.

At least one switching element may include a naturally-commutated switching device, such as the type used in line commutated converters (LCC) for HVDC applications, e.g. a thyristor or a diode. The use of at least one naturally-commutated switching device in each limb portion not only improves the robustness of the limb portions, but also makes the limb portions capable of withstanding surge currents that might occur due to faults in the DC electrical network due to their construction.

At least one switching element may include a self-commutated switching device. The self-commutated switching device may be an insulated gate bipolar transistor, a gate turn-off thyristor, a field effect transistor, an injection-enhanced gate transistor, an integrated gate commutated thyristor or any other self-commutated semiconductor device.

Optionally each limb portion may include at least one pair of switching elements connected in anti-parallel so that each limb portion can conduct current in two directions. This allows the voltage source converter to be configured to transfer power between the AC and DC electrical networks in both directions. Each switching element of the or each pair of switching elements may include a single switching device or a plurality of series and/or parallel-connected switching devices.

In the voltage source converter according to the invention, each energy storage device may be any device that is capable of storing or releasing energy, e.g. a capacitor or battery.

In still further embodiments of the invention, a first end of the chain-link converter is connected to the AC terminal and a second end of the chain-link converter is connectable to ground.

The voltage source converter according to the invention may come in many different configurations.

For example, the voltage source converter may include at least one inductor that is connected at its first end to the AC terminal and is connectable at its second end to the AC electrical network, wherein the chain-link converter is connected to the AC terminal via the inductor or a respective one of the inductors. The configuration of the voltage source converter in this manner extends the available period of conduction for the switching elements of the limb portions and thereby enables continuous operation of the chain-link converter.

The voltage source converter may be a multi-phase voltage source converter. In embodiments of the invention in which the voltage source converter is connectable to a multi-phase AC network, the voltage source converter may include a plurality of converter limbs, the AC terminal of each converter limb being connectable to a respective phase of a multi-phase AC network, each chain-link converter being connected to a respective one of the AC terminals.

Preferred embodiments of the invention will now be described, by way of a non-limiting example, with reference to the accompanying drawings in which:

FIGS. 1a, 1 b and 1c show, in schematic form, prior art voltage source converters;

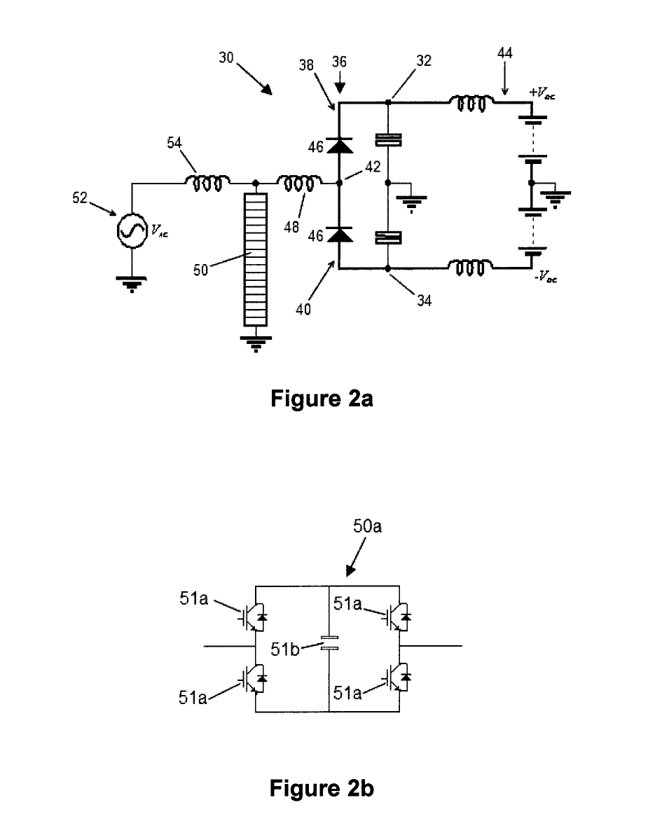

FIG. 2a shows, in schematic form, a voltage source converter according to a first embodiment of the invention;

FIG. 2b shows the structure of a 4-quadrant bipolar module forming part of a chain-link converter of the voltage source converter of FIG. 2a;

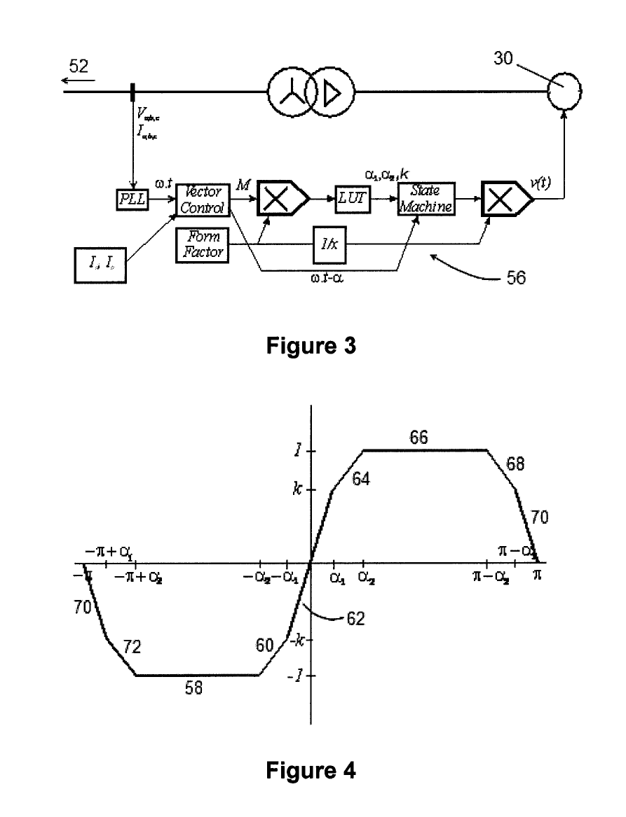

FIG. 3 shows, in schematic form, a control unit forming part of the voltage source converter of FIG. 2a;

FIGS. 4 to 10 illustrate, in graph form, the operation of the voltage source converter of FIG. 2a;

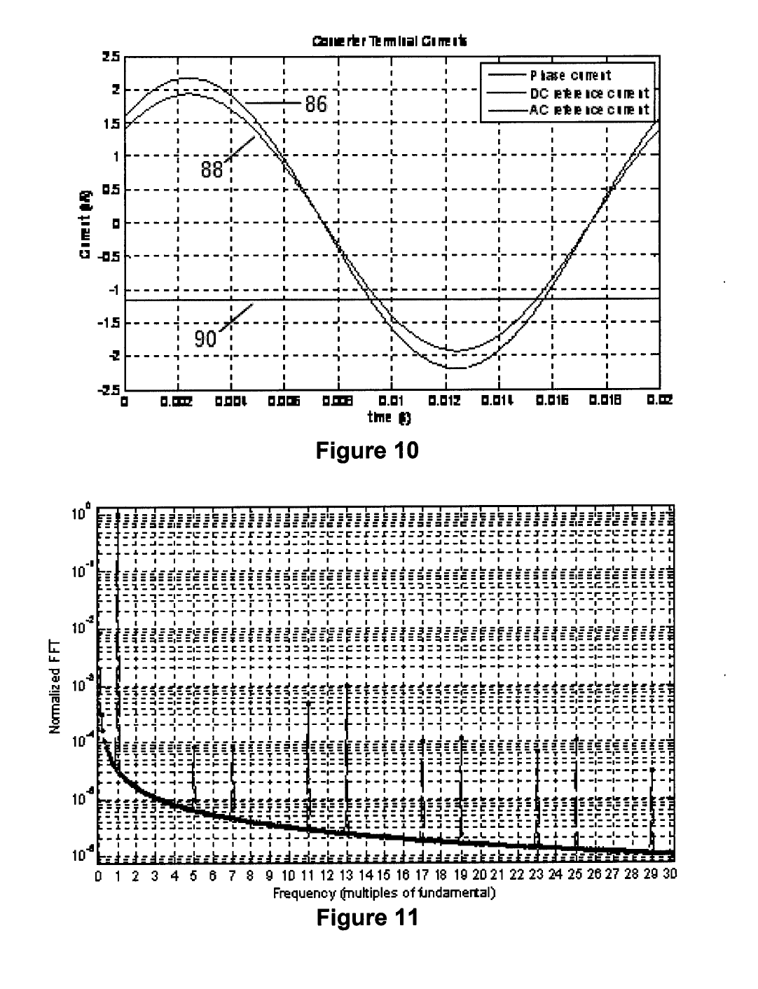

FIG. 11 illustrates, in graph form, a frequency analysis of an AC phase current generated at the AC terminal of the voltage source converter of FIG. 2a;

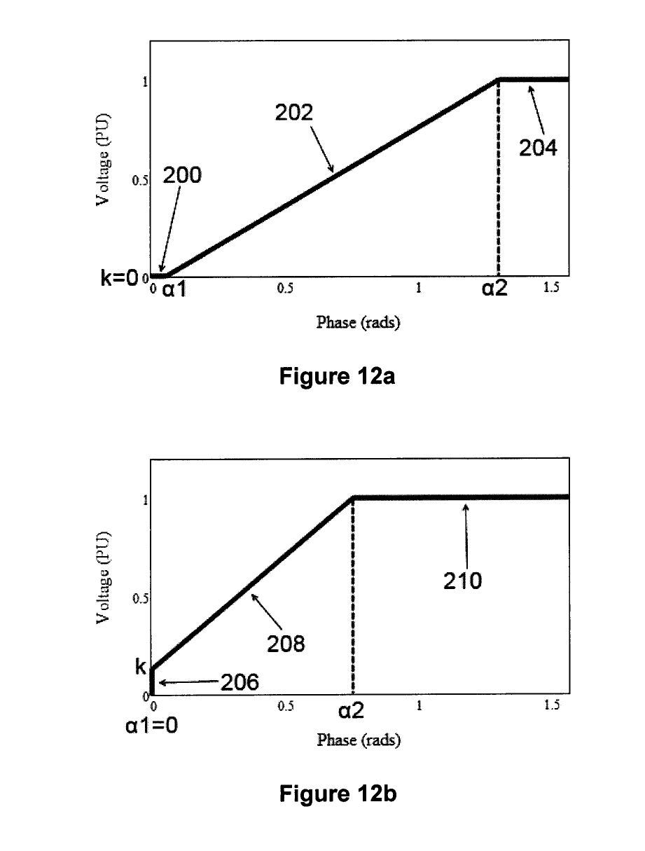

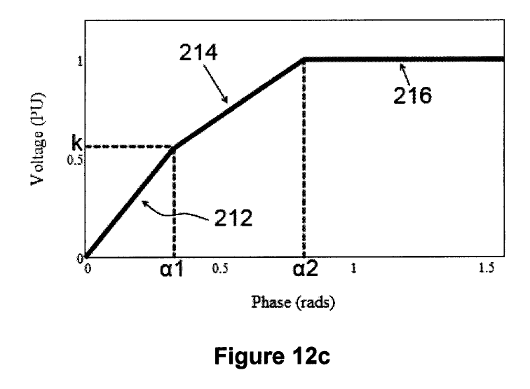

FIGS. 12a to 12c illustrate, in graph form, further examples of the operation of the voltage source converter of FIG. 2a;

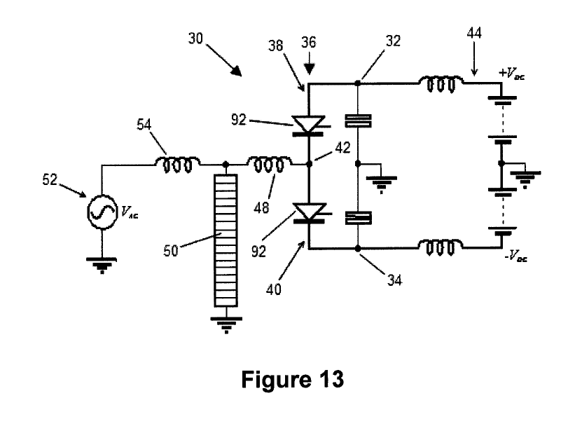

FIG. 13 shows, in schematic form, a voltage source converter according to a second embodiment of the invention; and

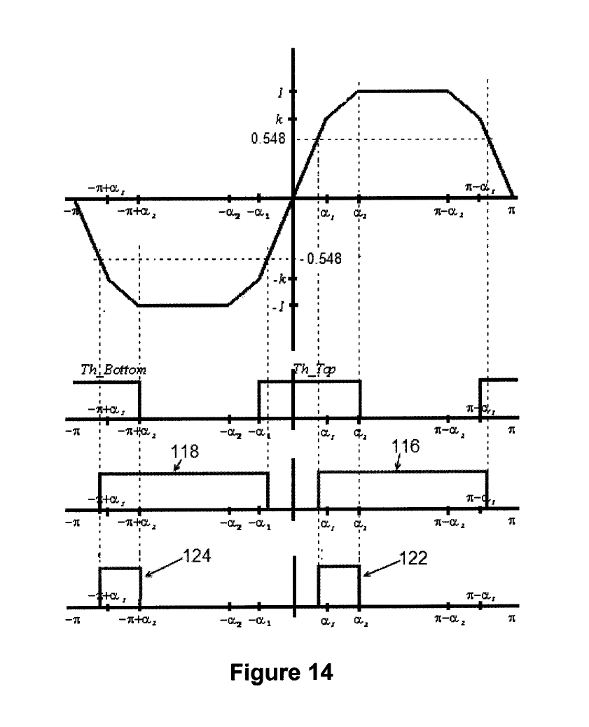

FIGS. 14 to 17 illustrate, in graph form, the operation of the voltage source converter of FIG. 13.

A first voltage source converter 30 according to an embodiment of the invention is shown in FIG. 2a.

The first voltage source converter 30 comprises first and second DC terminals 32,34 and a converter limb 36.

The converter limb 36 extend between first and second DC terminals 32,34, and has first and second limb portions 38,40 separated by an AC terminal 42. In other words, the first limb portion 38 is connected between the first DC terminal 32 and the AC terminal 42, and the second limb portion 40 is connected between the second DC terminal 34 and the AC terminal 42.

In use, the first and second DC terminals 32,34 are respectively connected to positive and negative terminals of a DC electrical network 44, the positive and negative terminals of the DC electrical network 44 carrying voltages of +Vdc and −Vdc respectively.

Each limb portion 38,40 includes a director switch 46, which includes a single switching element. Each switching element includes a diode. The use of diodes in the limb portions 38,40 not only improves the robustness of the limb portions 38,40, but also makes the limb portions 38,40 capable of withstanding surge currents that might occur due to faults in the DC electrical network 44.

It is envisaged that, in other embodiments of the invention, each switching element may be replaced by a plurality of series-connected switching elements to increase the voltage rating of each limb portion 38,40.

The first voltage source converter 30 further includes an inductor 48 and a chain-link converter 50. A first end of the inductor 48 is connected to a first end of the chain-link converter 50. A second end of the inductor 48 is connected to the AC terminal 42.

In use, the first ends of the inductor 48 and chain-link converter 50 are connected to an AC electrical network 52 via a phase reactance 54, and a second end of the chain-link conductor is connected to ground.

Such connection of the chain-link converter 50 to the AC terminal 42 means that, in use, each limb portion 38,40 is switchable to switch the chain-link converter 50 into and out of circuit with that limb portion and thereby switch the chain-link converter 50 into and out of circuit with the corresponding DC terminal 32,34.

The chain-link converter 50 includes a plurality of series-connected modules 50a. Each module 50a includes two pairs of switching elements, each of which is referred to hereon as a “module switch” 51a, and an energy storage device in the form of a capacitor 51b, as shown in FIG. 2b. The module switches 51a are connected in parallel with the capacitor 51b in a full-bridge arrangement to define a 4-quadrant bipolar module that can provide negative, zero or positive voltage and can conduct current in two directions.

The modular arrangement of the chain-link converter 50 means that it is straightforward to increase or decrease the number of modules 50a in the chain-link converter 50 to achieve a desired voltage rating of the first voltage source converter 30.

Each module switch 51a is constituted by a semiconductor device in the form of an Insulated Gate Bipolar Transistor (IGBT). Each IGBT 51a is connected in parallel with an anti-parallel diode. It is envisaged that, in other embodiments of the invention, each module switch may be a different switching device such as a gate turn-off thyristor, a field effect transistor, an injection-enhanced gate transistor, an integrated gate commutated thyristor or any other self-commutated semiconductor device.

It is envisaged that, in other embodiments of the invention, the capacitor 51b may be replaced by another energy storage device that is capable of storing or releasing energy, e.g. a battery.

The capacitor 51b of each module 50a is selectively bypassed or inserted into the corresponding chain-link converter 50 by changing the state of the module switches 51a. This selectively directs current through the capacitor 51b or causes current to bypass the capacitor 51b, so that each module 50a provides a negative, zero or positive voltage.

The capacitor 51b of each module 50a is bypassed when the pairs of module switches 51a in each module 50a are configured to form a short circuit in the module 50a. This causes current in the chain-link converter 50 to pass through the short circuit and bypass the capacitor 51b, and so the module 50a provides a zero voltage, i.e. the module is configured in a bypassed mode.

The capacitor 51b of each module 50a is inserted into the chain-link converter 50 when the pairs of module switches 51a in each module 50a are configured to allow the current in the chain-link converter 50 to flow into and out of the capacitor 51b. The capacitor 51b then charges or discharges its stored energy so as to provide a non-zero voltage, i.e. the module 50a is configured in a non-bypassed mode. The full-bridge arrangement of the module switches 51a of each module permits configuration of the module switches 51a to cause current to flow into and out of the capacitor 51b in either direction, and so each module 50a can be configured to provide a negative or positive voltage in the non-bypassed mode.

It is possible to build up a combined voltage across each chain-link converter 50, which is higher than the voltage available from each of its individual modules 50a, via the insertion of the capacitors 51b of multiple modules 50a, each providing its own voltage, into each chain-link converter 50. In this manner switching of the module switches 51a of each module 50a causes each chain-link converter 50 to provide a stepped variable voltage source, which permits the generation of a voltage waveform across each chain-link converter 50 using a step-wise approximation. Such switching of each module 50a can be carried out to control the configuration of an AC voltage waveform at the AC terminal 42.

The manner in which the chain-link converter 50 is connected to the AC terminal 42, as set out above, extends the available period of conduction for the switching elements of the limb portions 38,40 and thereby enables continuous operation of the chain-link converter 50.

The first voltage source converter 30 further includes a control unit 56 to control the switching of the switching elements in each module 50a of the chain-link converter 50, as shown in FIG. 3.

Operation of the first voltage source converter 30 of FIG. 2a is described as follows, with reference to FIGS. 3 to 10.

The control unit 56 controls the switching of the switching elements in each module 50a of the chain-link converter 50 to provide a stepped variable voltage source to generate and control the configuration of a voltage at the AC terminal 42, as shown in FIG. 4.

When the voltage at the AC terminal 42 is at a negative value and exceeds Vdc in magnitude, the diode in the second limb portion 40 becomes forward-biased. At this stage the diode in the first limb portion 38 remains reversed biased. This means that the second limb portion 40 is switched into circuit and the first limb portion 38 remains switched out of circuit. Current therefore flows in the second limb portion 40, the current being limited by the inductor 48, but is inhibited from flowing in the first limb portion 38. In this manner the AC electrical network 52 and the chain-link converter 50 are switched into circuit with the second limb portion 40 and therefore the second DC terminal 34 and the negative terminal of the DC electrical network 44.

After a set period of time, the control unit 56 controls the switching of the switching elements in each module 50a of the chain-link converter 50 to increase the voltage at the AC terminal 42. Once the voltage at the AC terminal 42 no longer exceeds Vdc in magnitude, the current flowing in the inductor 48 starts to decrease until it reaches zero and stops flowing, at which point the diode in the second limb portion 40 stops being forward-biased. As such the AC electrical network 52 and the chain-link converter 50 are switched out of circuit with the second limb portion 40 and therefore the second DC terminal 34 and the negative terminal of the DC electrical network 44.

The control unit 56 then controls the switching of the switching elements in each module 50a of the chain-link converter 50 to ramp the voltage at the AC terminal 42 in a positive direction. The diodes of the first and second limb portions 38,40 remain reverse biased from the instant at which the current in the inductor 48 stops flowing and for the remainder of the ramping stage, which means that there is zero current flow in the first and second limb portions 38,40.

When the voltage at the AC terminal 42 reaches a positive value and exceeds Vdc in magnitude, the diode in the first limb portion 38 becomes forward-biased. At this stage the diode in the second limb portion 40 remains reversed biased. This means that the first limb portion 38 is switched into circuit and the second limb portion 40 is switched out of circuit. Current therefore flows in the first limb portion 38, the current being limited by the inductor 48, but is inhibited from flowing in the second limb portion 40. In this manner the AC electrical network 52 and the chain-link converter 50 are switched into circuit with the first limb portion 38 and therefore the first DC terminal 32 and the positive terminal of the DC electrical network 44.

After a set period of time, the control unit 56 controls the switching of the switching elements in each module 50a of the chain-link converter 50 to decrease the voltage at the AC terminal 42. Once the voltage at the AC terminal 42 no longer exceeds Vdc in magnitude, the current flowing in the inductor 48 starts to decrease until it reaches zero and stops flowing, at which point the diode in the first limb portion 38 stops being forward-biased. As such the AC electrical network 52 and the chain-link converter 50 are switched out of circuit with the first limb portion 38 and therefore the first DC terminal 32 and the positive terminal of the DC electrical network 44.

The control unit 56 then controls the switching of the switching elements in each module 50a of the chain-link converter 50 to ramp the voltage at the AC terminal 42 in a negative direction until the voltage at the AC terminal 42 is at a negative value and exceeds Vdc in magnitude. As mentioned earlier, the diodes of the first and second limb portions 38,40 remain reverse biased from the instant at which the current in the inductor 48 stops flowing and for the remainder of the ramping stage, which means that there is zero current flow in the first and second limb portions 38,40.

In this manner the chain-link converter 50 is controlled to generate an AC voltage waveform at the AC terminal 42, in which the voltage at the AC terminal 42 commutates between positive and negative peak values, each of which exceeds Vdc in magnitude.

When the control unit 56 controls the switching of the switching elements in each module 50a of the chain-link converter 50 to generate and control the configuration of the AC voltage waveform at the AC terminal 42, the shape of the AC voltage waveform is defined as follows.

The configuration of the AC voltage waveform at the AC terminal 42 is controlled such that the AC voltage waveform is symmetrical about the phase angles −π/2 and π/2 and is asymmetrical about zero phase angle and that an AC voltage waveform portion including different voltage profiles, with at least one of the different voltage profiles being defined by a non-zero voltage slope, (e.g. first and second non-zero voltage slopes as shown in FIG. 4) is generated between the positive and negative peak values of the AC voltage waveform at the AC terminal 42.

As shown in FIG. 4, the AC voltage waveform includes:
a first section 58 with a negative voltage at the AC terminal 42 that exceeds Vdc in magnitude (which is the negative peak value of the AC voltage waveform) and with a zero voltage slope;
a second section 60 with the first non-zero voltage slope;
a third section 62 with the second non-zero voltage slope, the third section 62 extending through zero phase angle;
a fourth section 64 with the first non-zero voltage slope; and
a fifth section 66 with a positive voltage at the AC terminal 42 that exceeds Vdc in magnitude (which is the positive peak value of the AC voltage waveform) and with a zero voltage slope;
sixth, seventh and eighth sections 68,70,72 which are shaped as the inverse of the second, third and fourth sections 60,62,64 respectively.

The sequence of generation of the different sections 58,60,62,64,66,68,70,72 of the AC voltage waveform is described as follows:
the first section 58 is followed by the second section 60. The common point of intersection between the first and second sections 58,60, i.e. a first intercept angle, corresponds to a phase angle of −α2;
the second section 60 is followed by the third section 62. The common point of intersection between the second and third sections 60,62, i.e. a second intercept angle, corresponds to a phase angle of −α1;
the third section 62 is followed by the fourth section 64. The common point of intersection between the third and fourth sections 62,64, i.e. a third intercept angle, corresponds to a phase angle of α1;
the fourth section 64 is followed by the fifth section 66. The common point of intersection between the fourth and fifth sections 64,66, i.e. a fourth intercept angle, corresponds to a phase angle of α2;
the fifth section 66 is followed by the sixth, seventh and eighth sections 68,70,72 in sequential order.

As such the AC voltage waveform includes a first non-zero voltage slope, a second non-zero voltage slope and a zero voltage slope over each of the periods −π to −π/2, −π/2 to 0, 0 to π/2 and π/2 to π.

The above sequence of generation repeats itself for as long as the first voltage source converter 30 is operated to transfer power between the AC and DC electrical networks 52,44.

The amplitude value of the AC voltage waveform that corresponds to the second intercept angle −α1 is equal to −k while the amplitude value of the AC voltage waveform that corresponds to the third intercept angle α1 is equal to k, whereby k is a value falling between zero and the magnitude of the first and fifth sections 58,66 of the AC voltage waveform.

In this manner the control unit 56 controls the switching of the switching elements in each module 50a of the chain-link converter 50 to generate an AC voltage waveform at the AC terminal 42, the AC voltage waveform including an AC voltage waveform portion between the positive and negative peak values of the AC voltage waveform, the AC voltage waveform portion including the first and second voltage slopes (namely the second, third and fourth sections 60,62,64 of the AC voltage waveform).

The configuration of the AC voltage waveform in this manner defines the number of degrees of freedom, i.e. α1, α2 and k, over the period 0 to π/2 of the AC voltage waveform. These degrees of freedom of the AC voltage waveform enable the control unit 56 to control the switching of the switching elements in each module 50a of the chain-link converter 50 to generate an AC voltage waveform in a manner that permits filtering of one or more harmonic components from the AC voltage waveform, as follows.

The Fourier expressions for the AC voltage waveform can be expressed using the three terms α1, α2 and k as defined above to give the magnitude for the ‘r^{th}’ harmonic, bᵣ, as: —

$${b}_{r} = \frac{4}{π} \cdot \frac{1}{( {α}_{2} - {α}_{1} ) \cdot {r}^{2}} \cdot [ ( 1 - \frac{{α}_{2}}{{α}_{1}} \cdot k ) \cdot sin ( r \cdot {α}_{1} ) - ( 1 - k ) \cdot sin ( r \cdot {α}_{2} ) ]$$

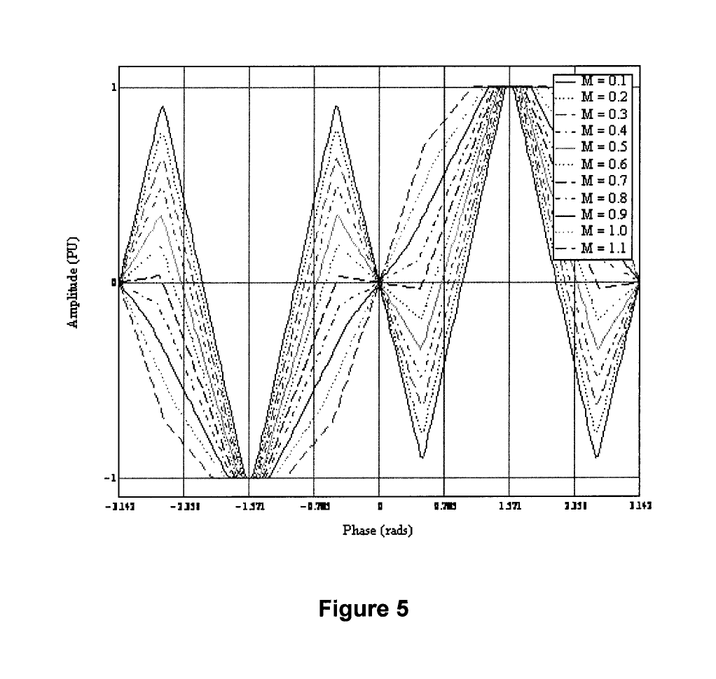

A set of three simultaneous equations are then formed, in which the fundamental magnitude for the AC voltage waveform is equated to a magnitude value M, and the magnitudes for the 5^{th} and 7^{th} harmonics are equated to zero as given below. These are then solved for the values of α₁, α₂ and k for a range of values of M, as illustrated in FIG. 5 which shows the different waveforms for different values of fundamental magnitude for the AC voltage waveform.

$$\frac{4}{π} \cdot \frac{1}{( {α}_{2} - {α}_{1} )} \cdot [ ( 1 - \frac{{α}_{2}}{{α}_{1}} \cdot k ) \cdot sin ( {α}_{1} ) - ( 1 - k ) \cdot sin ( {α}_{2} ) ] = M$$

$$\frac{4}{π} \cdot \frac{1}{( {α}_{2} - {α}_{1} ) \cdot 25} \cdot [ ( 1 - \frac{{α}_{2}}{{α}_{1}} \cdot k ) \cdot sin ( 5 \cdot {α}_{1} ) - ( 1 - k ) \cdot sin ( 5 \cdot {α}_{2} ) ] = 0$$

$$\frac{4}{π} \cdot \frac{1}{( {α}_{2} - {α}_{1} ) \cdot 49} \cdot [ ( 1 - \frac{{α}_{2}}{{α}_{1}} \cdot k ) \cdot sin ( 7 \cdot {α}_{1} ) - ( 1 - k ) \cdot sin ( 7 \cdot {α}_{2} ) ] = 0$$

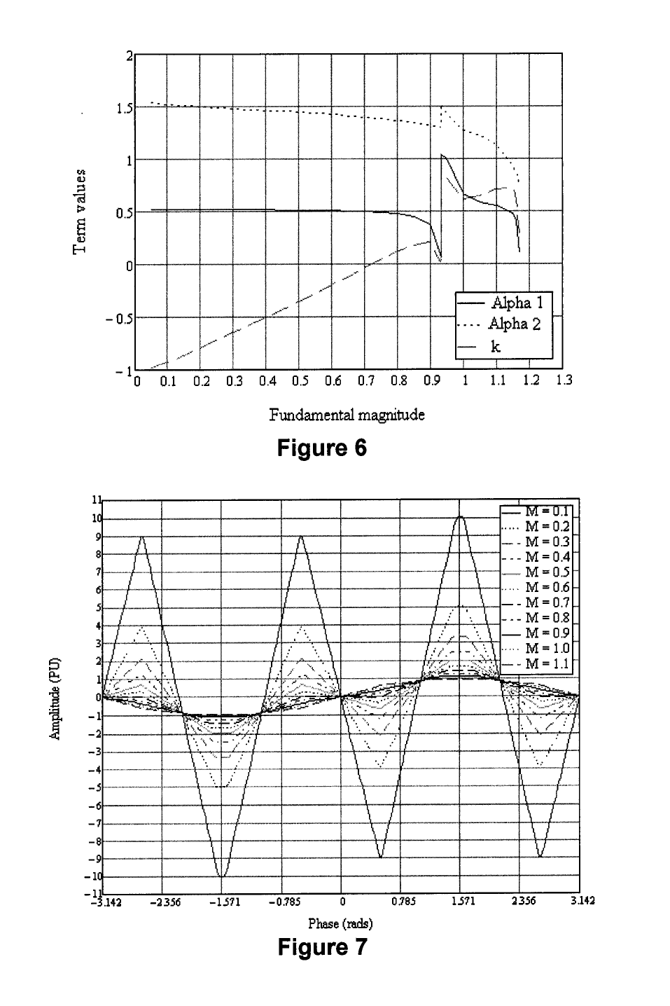

FIG. 6 illustrates, in graph form, the values of α1, α2 and k plotted against different values of fundamental magnitude for the AC voltage waveform. It can be seen from FIG. 6 that there is a discontinuity in the region of 0.931 which can be accounted for by using hysteresis. Other than the aforementioned discontinuity, the variation in the values of α1, α2 and k are generally linear and can therefore be determined using interpolation.

The control unit 56, as shown in FIG. 3, obtains a value for the required fundamental magnitude and phase offset of the AC voltage waveform using a vector control. The fundamental magnitude of the AC voltage waveform is then scaled using a form factor. FIG. 7 illustrates the scaling of the AC voltage waveform using a range of form factors with reference to a fundamental magnitude of 1.0 per unit.

The scaled fundamental magnitude is then passed to a look-up table (LUT) derived from the above equations to obtain the required values of α₁, α₂ and k, all of which are then passed to a state machine to obtain the time varying value of voltage required to be generated by the chain-link converter 50. Finally the time varying value of voltage is multiplied by the inverse of the form factor so that the net effect on the fundamental magnitude of the AC voltage waveform is neutral.

The control unit 56 then controls the switching of the switching elements in each module 50a of the chain-link converter 50 in accordance with the time varying value of voltage multiplied by the inverse of the form factor. As such the control unit 56 is able to control the switching of the switching elements in each module 50a of the chain-link converter 50 to generate the AC voltage waveform at the AC terminal 42, the AC voltage waveform including the AC voltage waveform portion with the first and second voltage slopes.

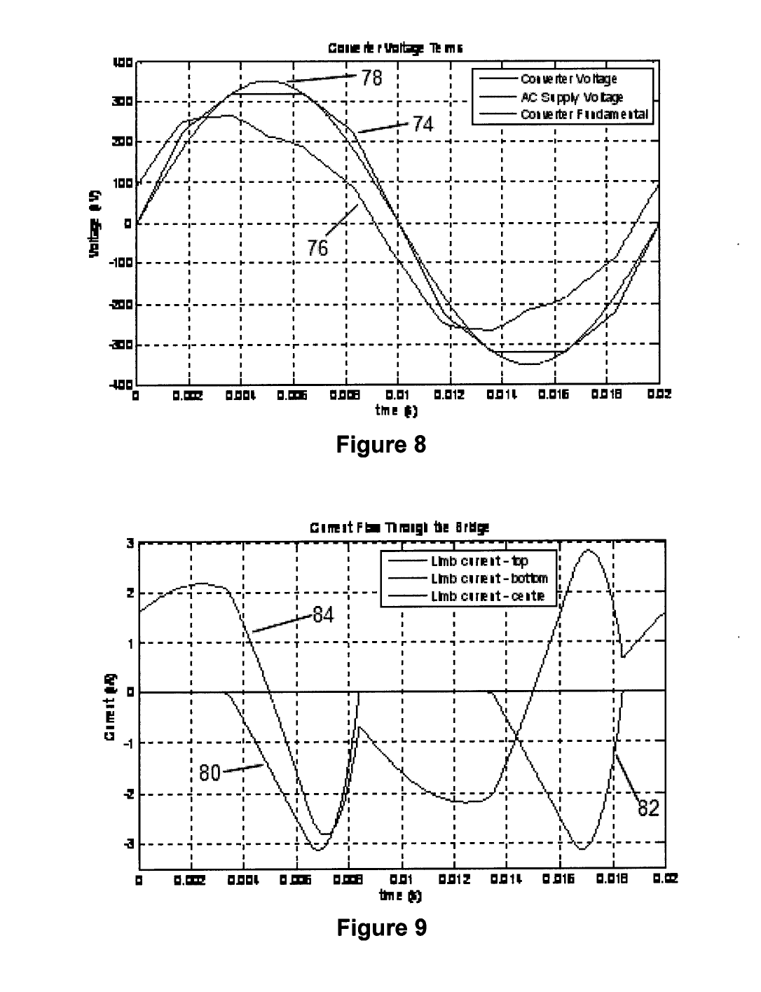

FIG. 8 compares, in graph form, the AC voltage waveform 74 generated at the AC terminal 42 of the first voltage source converter 30 against the AC voltage 76 of the AC electrical network 52 and a fundamental AC voltage waveform 78. It is seen from FIG. 8 that, whilst a significant level of harmonics is present in the AC voltage 76 of the AC electrical network 52, the chain-link converter 50 is nonetheless able to generate the required AC voltage waveform 74 including the AC voltage waveform portion with the first and second voltage slopes at the AC terminal 42.

FIG. 9 illustrates the variation in current 80,82,84 in the limb portions 38,40 and chain-link converter 50 of the first voltage source converter 30 of FIG. 2a. FIG. 10 compares the AC phase current 86 generated at the AC terminal 42 of the first voltage source converter 30 against AC and DC reference currents 88,90.

It is seen from FIG. 10 that the first voltage source converter 30 is capable of producing a high quality AC phase current 86 which indicates the effectiveness of the first voltage source converter 30 in transferring power from the DC electrical network 52 to the AC electrical network 44.

The generation of the AC voltage waveform at the AC terminal 42, the AC voltage waveform including an AC voltage waveform portion with the first and second voltage slopes, therefore causes the 5^{th} and 7^{th} harmonics to be filtered out of the AC voltage waveform generated at the AC terminal 42. This is illustrated in FIG. 11 which illustrates, in graph form, a frequency analysis of the AC phase current generated at the AC terminal 42. It can be seen from FIG. 11 that low levels of 5^{th} and 7^{th} harmonics are present in the AC phase current.

The filtering of the 5^{th} and 7^{th} harmonics from the AC voltage waveform may be carried out using different values for α1, α2 and k, examples of which are described as follows.

In one example, the control unit 56 may control the switching of the switching elements in each module 50a of the chain-link converter 50 to generate an AC voltage waveform at the AC terminal 42 so as to filter the 5^{th} and 7^{th} harmonics from the AC voltage waveform by forcing the value of k to zero. Such switching is carried out on the basis of the following set of simultaneous equations (which are derived from the abovementioned Fourier expressions):

$$\frac{4}{π} \cdot \frac{1}{( {α}_{2} - {α}_{1} ) \cdot 25} \cdot [ sin ( 5 \cdot {α}_{1} ) - sin ( 5 \cdot {α}_{2} ) ] = 0$$

$$\frac{4}{π} \cdot \frac{1}{( {α}_{2} - {α}_{1} ) \cdot 49} \cdot [ sin ( 7 \cdot {α}_{1} ) - sin ( 7 \cdot {α}_{2} ) ] = 0$$

The solution to the above simultaneous equations is: α1=0.045 rads, α2=1.302 rads, and k=0. FIG. 12a illustrates, in graph form, third, fourth and fifth sections 200,202,204 of the resultant AC voltage waveform whereby the third section 200 has a first voltage profile that is defined by a zero voltage slope, and the fourth section 202 has a second voltage profile that is defined by a positive voltage slope.

In another example, the control unit 56 may control the switching of the switching elements in each module 50a of the chain-link converter 50 to generate an AC voltage waveform at the AC terminal 42 so as to filter the 5^{th} and 7^{th} harmonics from the AC voltage waveform by forcing the value of α1 to zero. Such switching is carried out on the basis of the following set of simultaneous equations (which are derived from the abovementioned Fourier expressions):

$$\frac{4}{π} \cdot \frac{1}{( {α}_{2} - {α}_{1} ) \cdot 25} \cdot [ ( 1 - \frac{{α}_{2}}{{α}_{1}} \cdot k ) \cdot sin ( 5 \cdot {α}_{1} ) - ( 1 - k ) \cdot sin ( 5 \cdot {α}_{2} ) ] = 0$$

$$\frac{4}{π} \cdot \frac{1}{( {α}_{2} - {α}_{1} ) \cdot 49} \cdot [ ( 1 - \frac{{α}_{2}}{{α}_{1}} \cdot k ) \cdot sin ( 7 \cdot {α}_{1} ) - ( 1 - k ) \cdot sin ( 7 \cdot {α}_{2} ) ] = 0$$

$${α}_{1} = 0$$

The solution to the above simultaneous equations is: α1=0.000 rads, α2=0.756 rads, and k=0.136 Volts per unit. FIG. 12b illustrates, in graph form, third, fourth and fifth sections 206,208,210 of the resultant AC voltage waveform whereby the third section 206 has a first voltage profile that is defined by an instantaneous change in voltage, and the fourth section 208 has a second voltage profile that is defined by a positive voltage slope.

It can be seen from FIGS. 12a and 12b that using an AC voltage waveform that results from the value of α1 being forced to zero gives rise to a conduction time for each limb portion that is longer than a conduction time for each limb portion when using an AC voltage waveform that results from the value of k being forced to zero.

The first voltage source converter 30 of FIG. 2a is therefore capable of varying the harmonic content of the AC voltage waveform without affecting its fundamental voltage waveform. Such capability of the first voltage source converter 30 enables the first voltage source converter 30 to transfer high quality power between the AC and DC electrical networks 52,44.

In the embodiment shown, the 5^{th} and 7^{th} harmonics were selected to illustrate the filtering of harmonic components from the AC voltage waveform. Nevertheless it will be appreciated that the first voltage source converter 30 of FIG. 2a can also be operated to filter out other harmonics from the AC voltage waveform.

For example, the control unit 56 may control the switching of the switching elements in each module 50a of the chain-link converter 50 to generate an AC voltage waveform at the AC terminal 42 so as to filter the 5^{th}, 7^{th} and 11^{th} harmonics from the AC voltage waveform. Such switching is carried out on the basis of the following set of simultaneous equation (which are derived from the abovementioned Fourier expressions):

$$\frac{4}{π} \cdot \frac{1}{( {α}_{2} - {α}_{1} ) \cdot 25} \cdot [ ( 1 - \frac{{α}_{2}}{{α}_{1}} \cdot k ) \cdot sin ( 5 \cdot {α}_{1} ) - ( 1 - k ) \cdot sin ( 5 \cdot {α}_{2} ) ] = 0$$

$$\frac{4}{π} \cdot \frac{1}{( {α}_{2} - {α}_{1} ) \cdot 49} \cdot [ ( 1 - \frac{{α}_{2}}{{α}_{1}} \cdot k ) \cdot sin ( 7 \cdot {α}_{1} ) - ( 1 - k ) \cdot sin ( 7 \cdot {α}_{2} ) ] = 0$$

$$\frac{4}{π} \cdot \frac{1}{( {α}_{2} - {α}_{1} ) \cdot 121} \cdot [ ( 1 - \frac{{α}_{2}}{{α}_{1}} \cdot k ) \cdot sin ( 11 \cdot {α}_{1} ) - ( 1 - k ) \cdot sin ( 11 \cdot {α}_{2} ) ] = 0$$

The solution to the above simultaneous equations is: α1=0.340 rads, α2=0.814 rads, and k=0.565 Volts per unit. FIG. 12c illustrates, in graph form, third, fourth and fifth sections 212,214,216 of the resultant AC voltage waveform whereby the third and fourth sections 212,214 respectively have different voltage profiles that are defined by different, positive voltage slopes.

It will also be appreciated that the number of voltage profiles in the AC voltage waveform portion may be varied to further increase the number of degrees of freedom of the AC voltage waveform (i.e. the intercept angles of the AC voltage waveform, and each amplitude value of the AC voltage waveform that corresponds to the respective intercept angle), and thereby allow an increased number of harmonic components to be filtered out from the AC voltage waveform.

The operation of the first voltage source converter 30 to enable transfer of high quality power between the AC and DC electrical networks 52,44 permits simplification of the design and construction of the limb portions 38,40 without adversely affecting the performance of the first voltage source converter 30. Also, switching elements with high voltage ratings can be selected for use in the limb portions 38,40 to further reduce the footprint of the first voltage source converter 30 and thereby minimise the real estate costs of the associated power station.

Furthermore the configuration of the first voltage source converter 30 permits the chain-link converter 50 to provide a variable voltage to generate and control the configuration of the AC voltage waveform at the AC terminal 42 and thereby control the voltage experienced by the switching elements of the limb portions 38,40. Such generation and control of the configuration of the AC voltage waveform at the AC terminal 42 not only permits soft-switching of the limb portions 38,40, but also reduces the risk of damage caused by voltage levels exceeding the voltage ratings of the switching elements of the limb portions 38,40. In turn the first voltage source converter 30 becomes easier to design and manufacture because the switching elements of the limb portions 38,40 can be chosen without having to consider the possibility of voltage levels exceeding the voltage ratings of the switching elements. Moreover the chain-link converter 50 can be switched to control the configuration of the AC voltage waveform at the AC terminal 42 to prevent the voltage at the AC terminal 42 from ramping too quickly, thus causing fast fronted and high voltage spikes that may damage or degrade components or their insulation.

In addition the connection of the chain-link converter 50 to the AC terminal 42 as set out above permits reduction in the required number of modules 50a per converter limb 36 and per AC phase in comparison to a conventional voltage source converter having the same number of converter limbs, each converter limb including a plurality of modules, an example of which is shown in FIG. 1c. As such the reduction in the overall number of modules 50a provides further savings in terms of the cost, size and footprint of the first voltage source converter 30.

The configuration of the first voltage source converter 30 therefore results in an efficient, cost- and space-saving voltage source converter 30 with high voltage capabilities.

A second voltage source converter 130 according to a second embodiment of the invention is shown in FIG. 13. The second voltage source converter 130 of FIG. 13 is similar in structure and operation to the first voltage source converter 30 of FIG. 2a, and like features share the same reference numerals.

The second voltage source converter 130 differs from the first voltage source converter 30 in that, in the second voltage source converter, the switching element of each limb portion 38,40 includes a thyristor 92 instead of a diode.

The direction of the thyristor 92 in each limb portion 38,40 is configured to enable the second voltage source converter 130 to transfer power from the DC electrical network 44 to the AC electrical network 52, i.e. to operate as an inverter.

Furthermore the control unit 56 controls the switching of the thyristor 92 in each limb portion 38,40.

Operation of the second voltage source converter 130 of FIG. 13 is described as follows, with reference to FIGS. 14 to 17.

The control unit controls the switching of the switching elements in each module 50a of the chain-link converter 50 to provide a stepped variable voltage source to generate and control the configuration of a voltage at the AC terminal 42, as shown in FIG. 14.

In an initial state of the second voltage source converter 130, just before the voltage at the AC terminal 42 reaches a value which is negative and equal to Vdc in magnitude, the thyristor 92 in the first limb portion 38 is open and the thyristor 92 in the second limb portion 40 is closed. This means that the second limb portion 40 is switched into circuit and the first limb portion 38 is switched out of circuit. Current therefore flows in the second limb portion 40 from the DC electrical network 52 to the AC electrical network 44, the current being limited by the inductor 48, but is inhibited from flowing in the first limb. portion 38. In this manner the AC electrical network 52 and the chain-link converter 50 are switched into circuit with the second limb portion 40 and therefore the second DC terminal 34 and the negative terminal of the DC electrical network 44.

The control unit then controls the switching of the switching elements in each module 50a of the chain-link converter 50 to decrease the voltage at the AC terminal 42 until it reaches a value which is negative and exceeds Vdc in magnitude. At this time the voltage across the inductor 48 starts to decrease in magnitude until it reaches zero, at which point the thyristor 92 in the second limb portion 40 is commutated off. The thyristor 92 in the second limb portion 40 upon its subsequent recovery is able to support a voltage across its terminals.

After a set period of time has elapsed following the voltage at the AC terminal 42 reaching a value which is negative and exceeds Vdc in magnitude, the control unit 56 then controls the switching of the switching elements in each module 50a of the chain-link converter 50 to ramp the voltage at the AC terminal 42 in a positive direction. The thyristors 92 of the first and second limb portions 38,40 remain open from the instant at which the voltage in the inductor 48 reaches zero and for a predefined period forming part of the remainder of the ramping stage, which means that there is zero current flow in the first and second limb portions 38,40.

After the predefined period has elapsed and before the voltage at the AC terminal 42 reaches a value which is positive and equal to Vdc in magnitude, the control unit 56 generates a control signal to trigger the thyristor 92 of the first limb portion 38 into conduction. Therefore, the thyristor 92 in the first limb portion 38 is closed and the thyristor 92 in the second limb portion 40 remains open. This means that the first limb portion 38 is switched into circuit and the second limb portion 40 is switched out of circuit. Current therefore flows in the first limb portion 38 from the DC electrical network 52 to the AC electrical network, the current being limited by the inductor 48, but is inhibited from flowing in the second limb portion 40. In this manner the AC electrical network 52 and the chain-link converter 50 are switched into circuit with the first limb portion 38 and therefore the first DC terminal 32 and the positive terminal of the DC electrical network 44.

The control unit then controls the switching of the switching elements in each module 50a of the chain-link converter 50 to increase the voltage at the AC terminal 42 until it reaches a value which is positive and exceeds Vdc in magnitude. At this time the voltage across the inductor 48 starts to decrease in magnitude until it reaches zero, at which point the thyristor 92 in the first limb portion 38 is commutated off. The thyristor 92 in the first limb portion 40 upon its subsequent recovery is able to support a voltage across its terminals.

After a set period of time has elapsed following the voltage at the AC terminal 42 reaching a value which is positive and exceeds Vdc in magnitude, the control unit 56 controls the switching of the switching elements in each module 50a of the chain-link converter 50 to ramp the voltage at the AC terminal 42 in a negative direction. The thyristors 92 of the first and second limb portions 38,40 remain open from the instant at which the voltage in the inductor 48 reaches zero and for a predefined period forming part of the remainder of the ramping stage, which means that there is zero current flow in the first and second limb portions 38,40.

After the predefined period has elapsed and before the voltage at the AC terminal 42 reaches a value which is negative and equal to Vdc in magnitude, the control unit 56 generates a control signal to trigger the thyristor 92 of the second limb portion 40 into conduction. Therefore, the thyristor 92 in the first limb portion 38 is open and the thyristor 92 in the second limb portion 40 is closed, thus returning to the earlier-mentioned initial state of the second voltage source converter 130.

In this manner the chain-link converter 50 is controlled to generate an AC voltage waveform at the AC terminal 42, in which the voltage at the AC terminal 42 commutates between positive and negative peak values, each of which exceeds Vdc in magnitude.

When the control unit 56 controls the switching of the switching elements in each module 50a of the chain-link converter 50 to generate and control the configuration of the AC voltage waveform at the AC terminal 42, the shape of the AC voltage waveform is defined in the same manner as that described above with reference to the first voltage source converter 30 of FIG. 2a to filter one or more harmonic components from the AC voltage waveform.

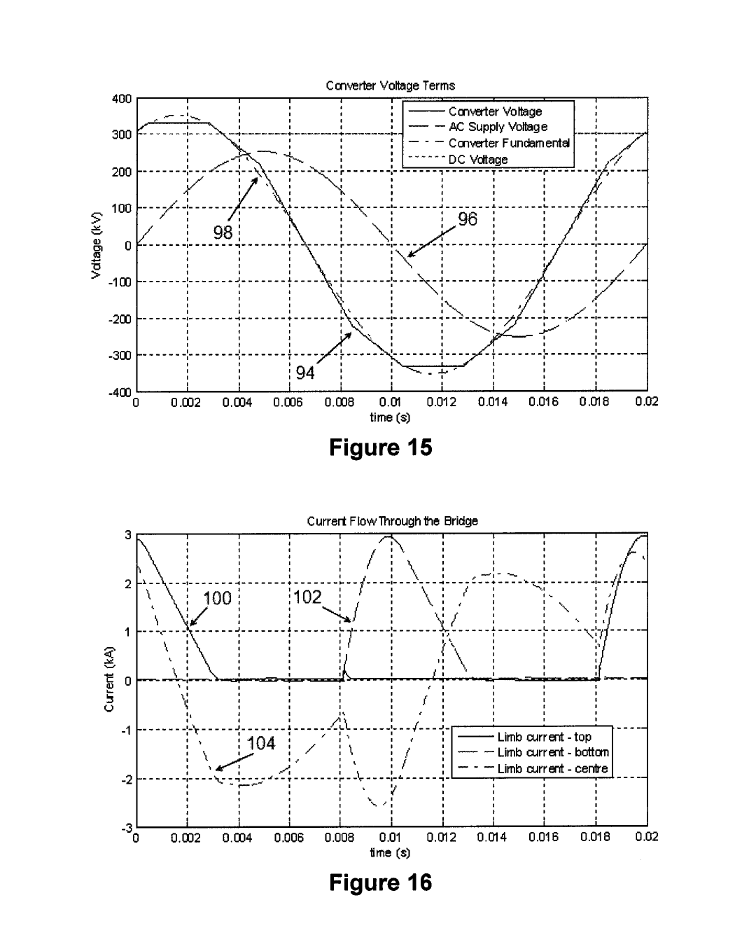

FIG. 15 compares, in graph form, the AC voltage waveform 94 generated at the AC terminal 42 of the second voltage source converter 130 against the AC voltage 96 of the AC electrical network 52 and a fundamental AC voltage waveform 98. It is seen from FIG. 15 that the chain-link converter 50 is able to generate the required AC voltage waveform 94 including the AC voltage waveform portion with the first and second voltage slopes at the AC terminal 42, and the required AC voltage waveform 94 closely follows the fundamental AC voltage waveform 98.

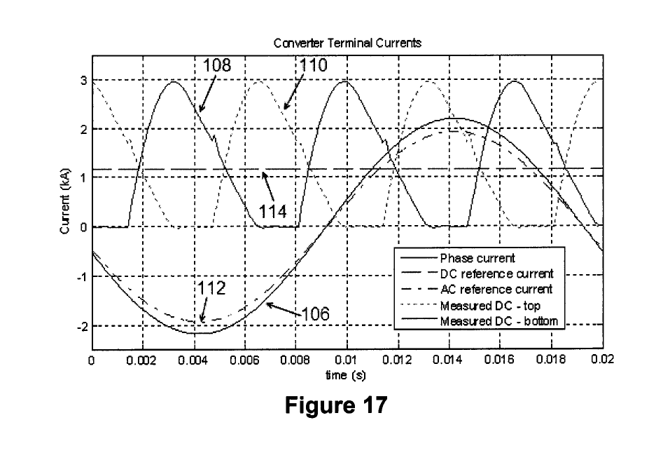

FIG. 16 illustrates the variation in current 100,102,104 in the limb portions 38,40 and chain-link converter 50 of the second voltage source converter 130 of FIG. 13. FIG. 17 compares the AC phase current 106 generated at the AC terminal 42 of the second voltage source converter 130 and DC currents 108,110 at the first and second DC terminals 32,34 of the second voltage source converter 130 against AC and DC reference currents 112,114.

It is seen from FIG. 17 that the second voltage source converter 130 is capable of producing a high quality AC phase current 106 which indicates the effectiveness of the second voltage source converter 130 in transferring power from the DC electrical network 52 to the AC electrical network 44.

The generation of a control signal by the control unit 56 to trigger the thyristor 92 in each limb portion 38,40 into conduction during the generation of the AC voltage waveform as the AC terminal 42 is described as follows.

The control of the thyristors 92 in the limb portions 38,40 is incorporated into a state machine. The state machine is configured to output two logic signals to indicate whether the voltage at the AC terminal 42 is being ramped in a positive or negative direction. The first logic signal indicating the positive ramp direction is used for triggering the thyristor 92 of the first limb portion 38 and is referred to as Th_top. The second logic signal indicating the negative ramp direction is used for triggering the thyristor 92 of the second limb portion 40 and is referred to as Th_bottom. The point during the ramping stage at which each thyristor 92 is triggered must be variable and will be set by a servo loop.

The control of the thyristors 92 further includes the use of two adjustable first and second thresholds, each of which corresponds to the point at which the respective thyristor 92 is to be triggered into conduction. The first threshold corresponds to the magnitude of the voltage at the AC terminal 42 exceeding a first set reference level (which is set to 0.548 in FIG. 14) and the second threshold corresponds to the magnitude of the voltage at the AC terminal 42 being less than a second set reference level (which is set to −0.548 in FIG. 14). It will be appreciated that the value for each set reference level may vary depending on the parameters of the associated power application.

The first logic signal Th_top is combined with an output logic signal 116 from a comparator associated with the first threshold to decide whether a control signal 122 should be generated to trigger the thyristor 92 of the first limb portion 38 into conduction. When the state machine outputs the first logic signal Th_top and the first threshold is met, the control signal 122 is generated by the control unit 56 to trigger the thyristor 92 of the first limb portion 38 into conduction.

Similarly, the second logic signal Th_bottom is combined with an output logic signal 118 from a comparator associated with the second threshold to decide whether a control signal 124 should be generated to trigger the thyristor 92 of the second limb portion 40 into conduction. When the state machine outputs the second logic signal Th_bottom and the second threshold is met, the control signal 124 is generated by the control unit 56 to trigger the thyristor 92 of the second limb portion 40 into conduction.

FIG. 14 illustrates the process of combining the first and second logic signals Th_top, Th_bottom with the output logic signals 116,118 from the comparators with reference to the voltage at the AC terminal 42 for deciding whether the control signals 122,124 should be generated.

It is envisaged that, in other embodiments of the invention, the voltage source converter may include a plurality of converter limbs and a plurality of chain-link converters, the AC terminal of each converter limb being connectable to a respective phase of a multi-phase AC network, each chain-link converter being connected to a respective one of the AC terminals.

It is further envisaged that, in other embodiments of the invention, the diode or thyristor in each limb portion may be replaced by at least one active switching element and the control unit is configured to selectively switch the active switching elements of the limb portions. The or each active switching element may include an insulated gate bipolar transistor, a gate turn-off thyristor, a field effect transistor, an injection-enhanced gate transistor, an integrated gate commutated thyristor or any other naturally-commutated or self-commutated semiconductor device. In such embodiments, the control unit may switch the active switching elements of the limb portions to turn on and off in the same manner as the switches of a conventional line commutated converter that is carrying out inversion or rectification between a DC voltage and an AC voltage.

Further optionally each active switching element may be replaced by a pair of active switching elements connected in anti-parallel to form a bidirectional director switch so that each limb portion can conduct current in two directions. This allows the voltage source converter to be configured to transfer power between the AC and DC electrical networks in both directions.

1. A voltage source converter comprising:
a converter limb extending between first and second DC terminals and having first and second limb portions separated by an AC terminal, the first and second DC terminals being connectable to a DC electrical network and the AC terminal being connectable to an AC electrical network, each limb portion including at least one switching element;
a chain-link converter including a plurality of series-connected modules, each module including at least one switching element and at least one energy storage device, the or each switching element and the or each energy storage device of each module combining to selectively provide a voltage source, the chain-link converter being connected to the AC terminal, the or each switching element of each limb portion being switchable to switch the chain-link converter into and out of circuit with that limb portion and thereby switch the chain-link converter into and out of circuit with the corresponding DC terminal; and
a control unit which coordinates the switching of the switching elements of the limb portions and the or each switching element in each module of the chain-link converter to transfer power between the AC and DC electrical networks,
wherein the control unit controls the switching of the or each switching element in each module of the chain-link converter to generate an AC voltage waveform at the AC terminal, the AC voltage waveform including an AC voltage waveform portion between positive and negative peak values of the AC voltage waveform, the AC voltage waveform portion including at least two different voltage profiles to filter one or more harmonic components from the AC voltage waveform, at least one of the different voltage profiles being defined by a non-zero voltage slope.

2. A voltage source converter according to claim 1 wherein at least two of the different voltage profiles are defined by different voltage slopes.

3. A voltage source converter according to claim 1 wherein at least one of the different voltage profiles is defined by an instantaneous change in voltage.

4. A voltage source converter according to claim 1 wherein the control unit is configured to control the switching of the or each switching element in each module of the chain-link converter to control the configuration of the AC voltage waveform portion at the AC terminal when the chain-link converter is switched out of circuit with both limb portions.

5. A voltage source converter according to claim 1 wherein the control unit controls the switching of the or each switching element in each module of the chain-link converter to modify the value of each intercept angle (α1,−α1,α2,−α2) of the AC voltage waveform and thereby filter out one or more harmonic components from the AC voltage waveform, each intercept angle (α1,−α1,α2,−α2) defining a phase angle corresponding to a common point of intersection between two different voltage profiles of the AC voltage waveform.

6. A voltage source converter according to claim 1 wherein the control unit controls the switching of the or each switching element in each module of the chain-link converter to modify the magnitude (k,−k) of the AC voltage waveform corresponding to each intercept angle (α1,−α1,α2,−α2) of the AC voltage waveform and thereby filter out one or more harmonic components from the AC voltage waveform, each intercept angle (α1,−α1,α2,−α2) defining a phase angle corresponding to a common point of intersection between two different voltage profiles of the AC voltage waveform.

7. A voltage source converter according to claim 1 wherein the or each switching element and the or each energy storage device of each module combine to selectively provide a bidirectional voltage source.

8. A voltage source converter according to claim 7 wherein each module includes two pairs of switching elements connected in parallel with an energy storage device in a full-bridge arrangement to define a 4-quadrant bipolar module that can provide negative, zero or positive voltage and can conduct current in two directions.

9. A voltage source converter according to claim 1 wherein each limb portion includes a single switching element or a plurality of switching elements connected in series between the AC terminal and a respective one of the DC terminals.

10. A voltage source converter according to claim 1 wherein at least one switching element includes a naturally-commutated or self-commutated switching device.

11. A voltage source converter according to claim 1 wherein each limb portion includes at least one pair of switching elements connected in anti-parallel so that each limb portion can conduct current in two directions.

12. A voltage source converter according to claim 1 wherein a first end of the chain-link converter is connected to the AC terminal and a second end of the chain-link converter is connectable to ground.

13. A voltage source converter according to claim 1 including an inductor (48) that is connectable at its first end to the AC electrical network and is connected at its second end to the AC terminal, wherein the chain-link converter is connected to the AC terminal via the inductor.

14. A voltage source converter according to claim 1 including a plurality of converter limbs and a plurality of chain-link converters, the AC terminal of each converter limb being connectable to a respective phase of a multi-phase AC network, each chain-link converter being connected to a respective one of the AC terminals.
